(19) United States
(12) Patent Application Publication
(10) Pub. No.: US 2009/0297971 A1
(43) Pub. Date: Dec. 3, 2009

(54) Image forming unit and image forming apparatus

(75) Inventor: Mikio Motomura, Tokyo (JP)

Correspondence Address: Kubotera & Associates, LLC, 200 Daingerfield Rd, Suite 202, Alexandria, VA, 22314, US

(73) Assignee: Oki Data Corporation

(21) Appl. No.: 12/453,758

(22) Filed: May 21, 2009

(30) Foreign Application Priority Data
May 30, 2008 (JP) 2008-143039

(51) Int. Cl. G03G 15/00; G03G 21/00

(52) U.S. Cl. 430/66; 399/159; 399/350

(57) ABSTRACT

An image forming unit includes a photosensitive member for forming a static latent image upon exposure and a developer image with developer. The photosensitive member includes a surface layer formed of a binder resin having a static frictional coefficient equal to or less than 0.535, and having a maximum surface roughness equal to or greater than 0.32 μm.

### BACKGROUND OF THE INVENTION AND RELATED ART STATEMENT

The present invention relates to an image forming unit and an image forming apparatus using an electro-photography process for forming a text and an image on a medium.

A conventional image forming apparatus using an electro-photography process for forming an image includes a printing apparatus, a copier, a facsimile, and the likes. In an electro-photography printer, one of such conventional image forming apparatus, high performance has been required recently such as improving image quality and high speed printing.

In a conventional image forming apparatus of one component non-magnetic contact developing type, a roller contacts with a photosensitive drum for charging, i.e., contact charging. In this case, an outer additive of toner such as silica tends to accumulate on the photosensitive drum, thereby causing a filming, in which a white streak mark is formed in a printed image.

In the conventional image forming apparatus, the photosensitive drum has an outer surface formed of an electron charge transportation layer. In general, the electron charge transportation layer has a layered structure formed of an electron charge transportation agent and a binder resin dissolved in an organic solvent and formed in a film shape. In order to prevent the filming, after the electron charge transportation layer is formed in the film shape, the photosensitive drum is configured to have the outer surface with a frictional coefficient within a specific range. Accordingly, the outer surface of the photosensitive drum tends to wear only by a specific amount, thereby preventing the filming (refer to Patent Reference).

Patent Reference: Japan Patent Publication No. 2001-075425

### SUMMARY OF THE INVENTION

According to a first aspect of the present invention, an image forming unit includes a photosensitive member for forming a static latent image upon exposure and a developer image with developer. The photosensitive member includes a surface layer formed of a binder resin having a static frictional coefficient equal to or less than 0.535, and having a maximum surface roughness equal to or greater than 0.32 μm. image forming unit, comprising:

According to a second aspect of the present invention, an image forming unit includes a photosensitive member for forming a static latent image upon exposure and a developer image with developer. The photosensitive member includes a surface layer formed of a binder resin having a static frictional coefficient equal to or less than 0.631, and having a maximum surface roughness equal to or greater than 0.32 μm. The image forming unit further includes a cleaning member pressed against the photosensitive member with a pressing force equal to or greater than 38.3 gf·cm.

In the first aspect of the present invention, the image forming unit includes the photosensitive member for forming a static latent image upon exposure and a developer image with developer. The photosensitive member includes the surface layer formed of the binder resin having a static frictional coefficient less than 0.535, and having a maximum surface roughness greater than 0.32 μm. Accordingly, it is possible to stably form a good image without a printing problem due to a filming.

### BRIEF DESCRIPTION OF THE DRAWINGS

FIG. 1 is a schematic view showing an image forming apparatus according to a first embodiment of the present invention;

FIG. 2 is a schematic view showing an image forming unit of the image forming apparatus according to the first embodiment of the present invention;

FIG. 3 is a schematic view showing a photosensitive drum of the image forming unit according to the first embodiment of the present invention;

FIG. 4 is a flow chart showing a process of producing the photosensitive drum of the image forming apparatus according to the first embodiment of the present invention;

FIG. 5 is a schematic view showing a method of measuring a static frictional coefficient;

FIG. 6 is a schematic view showing a print medium printed with the image forming apparatus in a continuous printing operation according to the first embodiment of the present invention;

FIG. 7 is a schematic view showing a print medium with a half tone image printed with the image forming apparatus according to the first embodiment of the present invention;

FIG. 8 is a schematic view showing a print medium with a solid image printed with the image forming apparatus according to the first embodiment of the present invention;

FIG. 9 is a table showing evaluation results of the image forming apparatus according to the first embodiment of the present invention;

FIG. 10 is a graph showing the evaluation results of the image forming apparatus according to the first embodiment of the present invention;

FIG. 11 is a schematic view showing a cleaning blade of an image forming apparatus according to a second embodiment of the present invention;

FIG. 12 is a table showing evaluation results of an example No. 1 of the cleaning blade of the image forming apparatus according to the second embodiment of the present invention;

FIG. 13 is a graph showing the evaluation results of the example No. 1 of the cleaning blade of the image forming apparatus according to the second embodiment of the present invention;

FIG. 14 is a table showing evaluation results of an example No. 2 of the cleaning blade of the image forming apparatus according to the second embodiment of the present invention;

FIG. 15 is a graph showing the evaluation results of the example No. 2 of the cleaning blade of the image forming apparatus according to the second embodiment of the present invention;

FIG. 16 is a table showing evaluation results of an example No. 3 of the cleaning blade of the image forming apparatus according to the second embodiment of the present invention;

FIG. 17 is a graph showing the evaluation results of the example No. 3 of the cleaning blade of the image forming apparatus according to the second embodiment of the present invention;

FIG. 18 is a table showing evaluation results of an example No. 4 of the cleaning blade of the image forming apparatus according to the second embodiment of the present invention;

FIG. 19 is a graph showing the evaluation results of the example No. 4 of the cleaning blade of the image forming apparatus according to the second embodiment of the present invention;

FIG. 20 is a table showing evaluation results of an example No. 5 of the cleaning blade of the image forming apparatus according to the second embodiment of the present invention;

FIG. 21 is a graph showing the evaluation results of the example No. 5 of the cleaning blade of the image forming apparatus according to the second embodiment of the present invention;

FIG. 22 is a table showing evaluation results of an example No. 6 of the cleaning blade of the image forming apparatus according to the second embodiment of the present invention;

FIG. 23 is a graph showing the evaluation results of the example No. 6 of the cleaning blade of the image forming apparatus according to the second embodiment of the present invention;

FIG. 24 is a schematic view showing a chemical structure of polycarbonate resins A to C according to the first embodiment of the present invention;

FIG. 25 is a schematic view showing a chemical structure of polyester resins D and E according to the first embodiment of the present invention; and

FIG. 26 is a schematic view showing chemical structures of electron charge transportation materials a to d according to the first embodiment of the present invention.

### DETAILED DESCRIPTION OF THE PREFERRED EMBODIMENTS

Hereunder, embodiments of the present invention will be described in detail with reference to the accompanying drawings. In the accompanying drawings, similar components are designated with the same reference numerals.

### First Embodiment

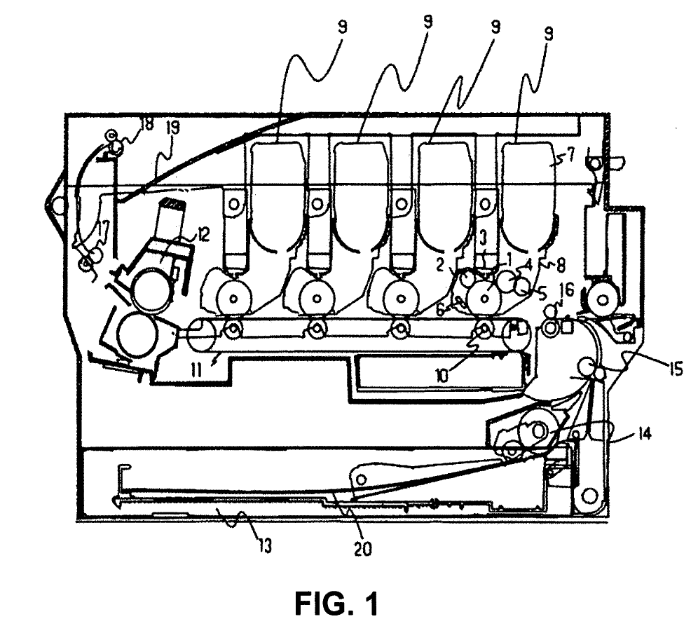

A first embodiment of the present invention will be explained. FIG. 1 is a schematic view showing an image forming apparatus according to the first embodiment of the present invention.

As shown in FIG. 1, the image forming apparatus includes a sheet supply cassette 13 for retaining a print medium 20. A sheet transport path of the print medium 20 is formed in a substantially S character shape extending from a sheet supply roller 14 to a transport roller 16, a transport roller 17, a discharge roller 18, and a discharge portion 19 through a transport roller 15 and a space between a photosensitive drum 1 and a transfer belt 11 of an image forming unit 9. Four image forming units 9 are arranged between the transport roller 16 and the transport roller 17 from an upstream side of the sheet transport path in an order of K (black), Y (yellow), M (magenta) and C (cyan).

In the embodiment, when the print medium 20 passes through between the photosensitive drum 1 and the transfer belt 11 of each of the image forming units 9, a toner image as a developer image in each color formed on the photosensitive drum 1 is transferred to the print medium 20 at a contact point between the photosensitive drum 1 and a transfer roller 10 disposed on an opposite side of the photosensitive drum 1 with the transfer belt 11 in between.

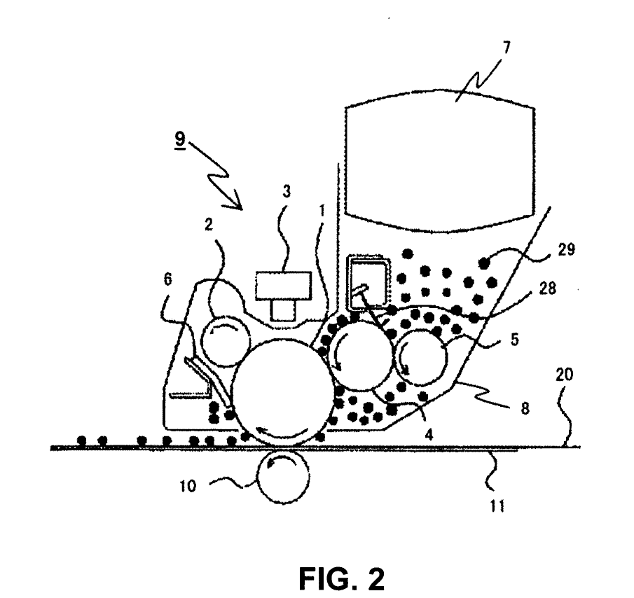

A configuration of the image forming units 9 will be explained next. The image forming units 9 have an identical configuration. FIG. 2 is a schematic view showing the image forming unit 9 of the image forming apparatus according to the first embodiment of the present invention.

As shown in FIG. 2, the image forming unit 9 includes a toner cartridge 7 filled with toner and a drum cartridge 8. The drum cartridge 8 includes the photosensitive drum 1; a charge roller 2 for charging the photosensitive drum 1; a developing roller 4 for developing a static latent image; a developing blade 28 for forming a uniform layer of toner 29 on the developing roller 4; a sponge roller 5 for stirring and charging the toner 29; and a cleaning blade 6 for cleaning toner 29 remaining on the photosensitive drum 1 after the toner image is transferred to the print medium 20.

Further, an exposure LED (light Emitting Diode) head 3 is disposed on a main body of the image forming apparatus for forming a static latent image on the photosensitive drum 1. The exposure LED head 3 is arranged such that the exposure LED head 3 is capable of exposing the photosensitive drum 1 from a specific position of the drum cartridge 8. When the transfer belt 11 transports the print medium 20, a toner image developed from a static latent image formed on the photosensitive drum 1 is transferred to the print medium 20 at the contact point between the photosensitive drum 1 and the transfer roller 10 disposed on an opposite side of the photosensitive drum 1 with the transfer belt 11 in between.

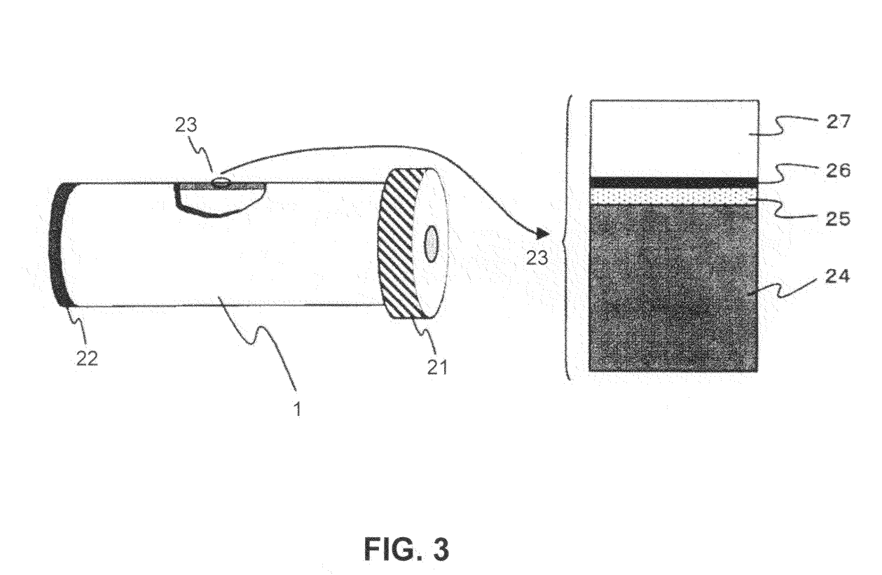

A configuration of the photosensitive drum 1 of the image forming apparatus will be explained next. FIG. 3 is a schematic view showing the photosensitive drum 1 of the image forming unit according to the first embodiment of the present invention.

As shown in FIG. 3, the photosensitive drum 1 includes a drum gear 21, a drum flange 22, and a photosensitive layer portion 23 formed of a photosensitive layer coated on a conductive supporting member 24 formed in a cylindrical shape. The photosensitive layer portion 23 has a laminated structure formed of a blocking layer 25, an electron charge generation layer 26, and an electron charge transportation layer 27 laminated on a surface of the conductive supporting member 24 in this order.

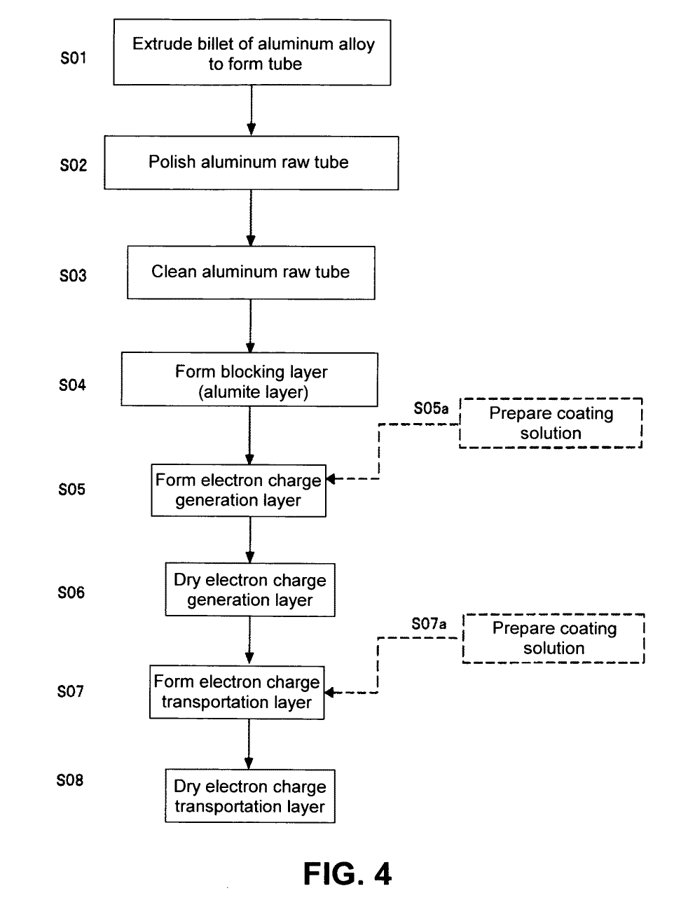

A process of producing the photosensitive drum 1 will be explained next. FIG. 4 is a flow chart showing the process of producing the photosensitive drum 1 of the image forming apparatus according to the first embodiment of the present invention.

In step S01, a billet of an aluminum alloy such as JIS-A3000 type alloy, in which silicone is added to aluminum, as a raw material of the conductive supporting member 24 is extruded with a porthole method to form a tube.

In step S02, the tube is machined to have a specific thickness and an outer diameter. At the same time, a surface of the tube is adjusted. In the embodiment, the tube is machined to have an outer diameter of 30 mm, a length of 246 mm, and a thickness of 0.75 mm, thereby obtaining the conductive supporting member 24 (an aluminum raw tube). Further, the aluminum raw tube is polished to obtain two types of the aluminum raw tubes having a ten-point average surface roughness Rz of about 0.8 μm or about 1.0 μm, respectively.

In step S03, the aluminum raw tube thus machined is transported to a cleaning bath for cleaning, thereby removing grease or dusts on a surface thereof. In step S04, the aluminum raw tube thus cleaned is treated to form the blocking layer 25. More specifically, the aluminum raw is treated with an anode oxidation process followed by a hole filling process with nickel acetate as a main component, thereby forming the blocking layer 25 formed of an anode oxide film (an alumite layer) with a thickness of 6.0 μm.

In step S05a and step S05, the electron charge generation layer 26 is formed on the alumite layer. More specifically, in forming the electron charge generation layer 26, the aluminum raw tube with the alumite layer formed thereon is immersed in a solution bath filled with a coating solution for forming the electron charge generation layer 26 prepared in advance.

In the embodiment, the coating solution is coated on the alumite layer through immersion coating, so that the electron charge generation layer 26 has a thickness of about 0.3 μm. In preparing the coating solution for forming the electron charge generation layer 26, 10 parts of oxo-titanium-phthalocyanine is added to 150 parts of 1,2-dimethoxyethane to obtain 160 parts of a pigment dispersion solution through a pulverization dispersion process with a sand grind mill. Then, 160 parts of the pigment dispersion solution is mixed with 100 parts of a binder solution having a solid component concentration of 5%, in which 5 parts of poly (vinyl butyral) is dissolved in 95 parts of 1,2-dimethoxyethane. In the final step, it is adjusted such that 1,2-dimethoxyethane and 4-methoxy-4-methylbentanone-2 become 9 to 1 and the solid component concentration becomes 4%, thereby obtaining the coating solution for forming the electron charge generation layer 26.

In step S06, the electron charge generation layer 26 formed on the aluminum raw tube through the immersion coating is dried to remove remaining solvent in the electron charge generation layer 26. Accordingly, the electron charge generation layer 26 is fixed to the alumite layer.

In step S07a and step S07, the electron charge transportation layer 27 is formed on the electron charge generation layer 26. More specifically, in forming the electron charge transportation layer 27, the aluminum raw tube with the electron charge generation layer 26 formed thereon is immersed in a solution bath filled with a coating solution for forming the electron charge transportation layer 27 prepared in advance. In the embodiment, the electron charge transportation layer 27 is formed through the immersion coating to have a thickness of about 18 μm.

In step S08, the electron charge transportation layer 27 formed on the electron charge transportation layer 27 is dried to remove remaining solvent in the electron charge transportation layer 27. Accordingly, the electron charge transportation layer 27 is fixed to the electron charge generation layer 26. In the embodiment, eight different coating solutions (described later) for forming the electron charge transportation layer 27 are prepared. The coating solutions are applied to the two types of the aluminum raw tubes with the different surface roughness to form eight different electron charge transportation layers thereon, respectively, thereby obtaining 16 examples of the photosensitive drum 1.

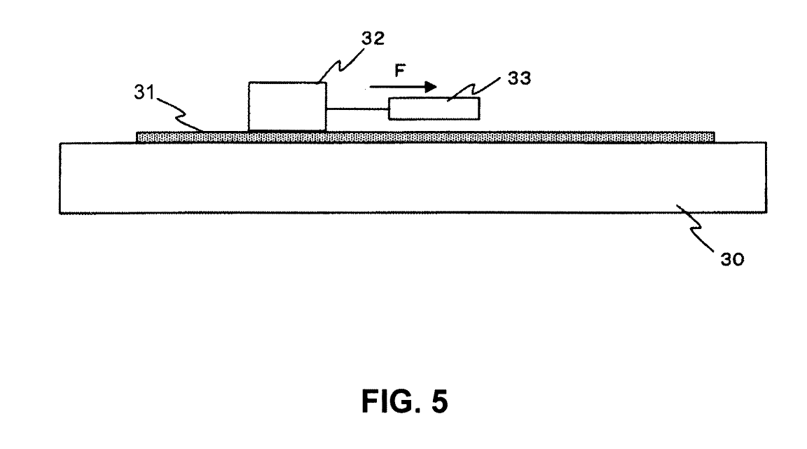

A method of measuring a static frictional coefficient will be explained next. FIG. 5 is a schematic view showing the method of measuring the static frictional coefficient. The coating solutions for forming the electron charge transportation layer 27 contain a binder resin. With the method shown in FIG. 5, the static frictional coefficient of a surface of the binder resin is measured.

In the method of measuring the static frictional coefficient, the binder resin is formed in a sheet 31 having a thickness of 1.0 mm. As shown in FIG. 5, the sheet 31 is placed on a horizontal table 30, and a cubic body 32 formed of aluminum is placed on the sheet 31. The cubic body 32 has a weight of 200 g and six surfaces polished in a mirror surface. A force gauge 33 horizontally pulls the cubic body 32, and measures a force F (gf) applied to the force gauge 33 at a moment when the cubic body 32 starts moving. The static frictional coefficient μs is calculated with the following equation:

μs=F/200

The surface roughness of the examples of the photosensitive drum 1 is measured with a contact type roughness meter at ten points, and a maximum surface roughness Ry is determined. It is found that the photosensitive drum 1 produced with a method (described later) has the maximum surface roughness Ry of 0.6 μm.

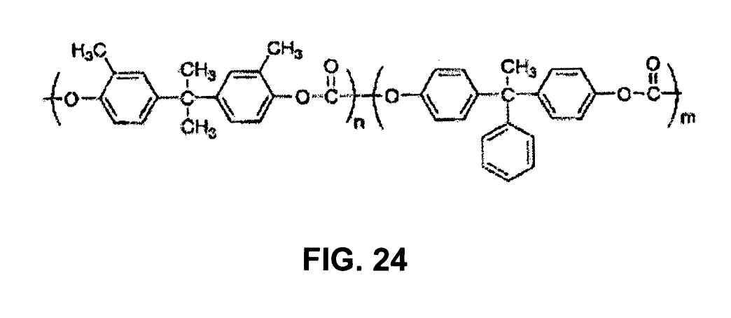

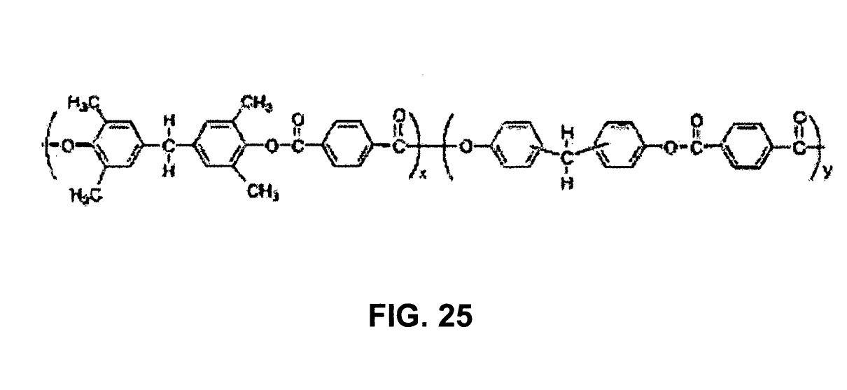

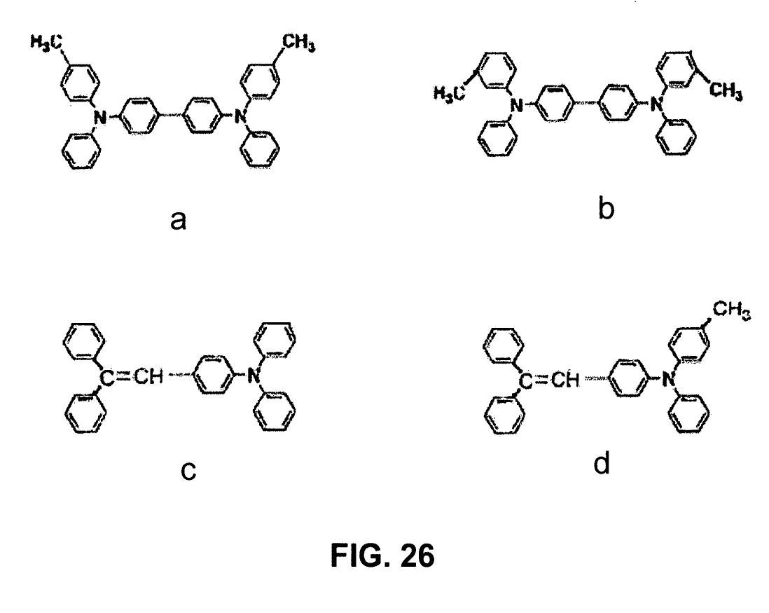

In the embodiment, the coating solutions for forming the electron charge transportation layer 27 include examples formed of the following eight compositions. The compositions contain polycarbonate resins A to C, polyester resins D to E, and electron charge transportation materials a to d. FIG. 24 is a schematic view showing a chemical structure of the polycarbonate resins A to C according to the first embodiment of the present invention. FIG. 25 is a schematic view showing a chemical structure of the polyester resins D and E according to the first embodiment of the present invention. FIG. 26 is a schematic view showing chemical structures of the electron charge transportation materials a to d according to the first embodiment of the present invention.

In the embodiment, the polycarbonate resins A to C have a viscosity average molecular weight of about 30,000. The polycarbonate resin A has a ratio of n relative to m (n:m) at 5 to 5 (5:5). The polycarbonate resin B has a ratio of n relative to m (n:m) at 4 to 6 (4:6). The polycarbonate resin C has a ratio of n relative to m (n:m) at 6 to 4 (6:4). The polyester resins D and E have a weight average molecular weight of about 150,000. The polyester resin D has a ratio of x relative to y (x:y) at 7 to 3 (7:3). The polyester resin E has a ratio of x relative to y (x:y) at 5 to 5 (5:5). The electron charge transportation materials a to d have the chemical structures shown in FIG. 26.

In the embodiment, an example #1 of the coating solution for forming the electron charge transportation layer 27 contains 100 parts of the polycarbonate resin A and 45 parts of the electron charge transportation material a both dissolved in a mixture of tetrahydrofuran and toluene at 80 to 20 (80:20).

In the embodiment, an example #2 of the coating solution for forming the electron charge transportation layer 27 contains 100 parts of the polycarbonate resin B and 45 parts of the electron charge transportation material a both dissolved in a mixture of tetrahydrofuran and toluene at 80 to 20 (80:20).

In the embodiment, an example #3 of the coating solution for forming the electron charge transportation layer 27 contains 100 parts of the polycarbonate resin C and 45 parts of the electron charge transportation material a both dissolved in a mixture of tetrahydrofuran and toluene at 80 to 20 (80:20).

In the embodiment, an example #4 of the coating solution for forming the electron charge transportation layer 27 contains 100 parts of the polyester resin D and 45 parts of the electron charge transportation material a both dissolved in a mixture of tetrahydrofuran and toluene at 80 to 20 (80:20).

In the embodiment, an example #5 of the coating solution for forming the electron charge transportation layer 27 contains 100 parts of the polyester resin E and 45 parts of the electron charge transportation material a both dissolved in a mixture of tetrahydrofuran and toluene at 80 to 20 (80:20).

In the embodiment, an example #6 of the coating solution for forming the electron charge transportation layer 27 contains 100 parts of the polyester resin D and 45 parts of the electron charge transportation material b both dissolved in a mixture of tetrahydrofuran and toluene at 80 to 20 (80:20).

In the embodiment, an example #7 of the coating solution for forming the electron charge transportation layer 27 contains 100 parts of the polyester resin D and 45 parts of the electron charge transportation material c both dissolved in a mixture of tetrahydrofuran and toluene at 80 to 20 (80:20).

In the embodiment, an example #8 of the coating solution for forming the electron charge transportation layer 27 contains 100 parts of the polyester resin D and 45 parts of the electron charge transportation material d both dissolved in a mixture of tetrahydrofuran and toluene at 80 to 20 (80:20).

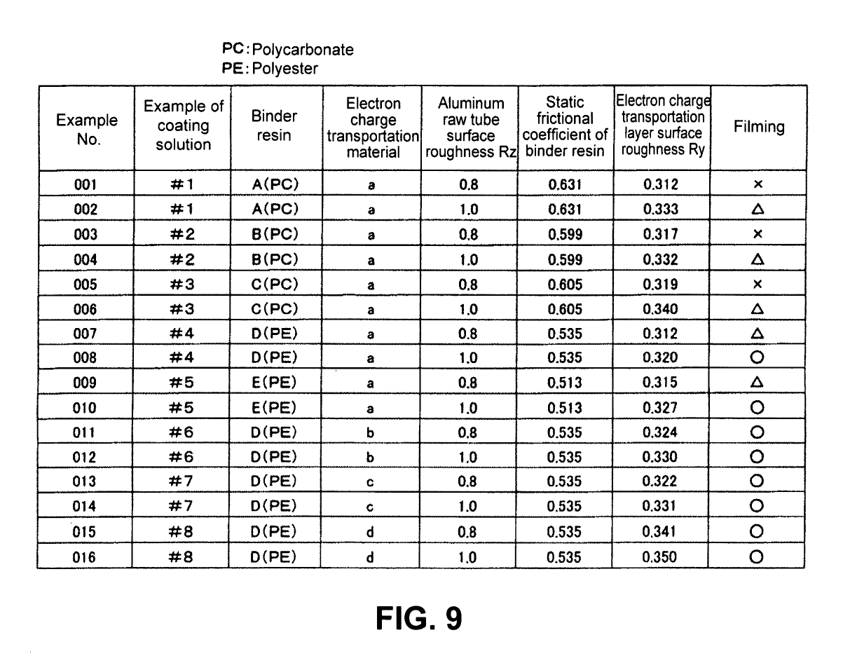

As described above, the eight coating solutions containing the different binder resins and the different electron charge transportation materials are applied to the two types of the aluminum raw tubes to obtain 16 examples 001 to 016 of the photosensitive drum 1 with the different maximum surface roughness Ry from 0.312 μm to 0.350 μm as shown in FIG. 9. FIG. 9 is a table showing evaluation results of the image forming apparatus according to the first embodiment of the present invention.

An evaluation of the examples of the photosensitive drum 1 will be explained. Using the image forming apparatus shown in FIG. 1, the examples of the photosensitive drum 1 were evaluated according to the following conditions. In the evaluation, crashed toner formed of one non-magnetic component having an average diameter of about 6 μm was used.

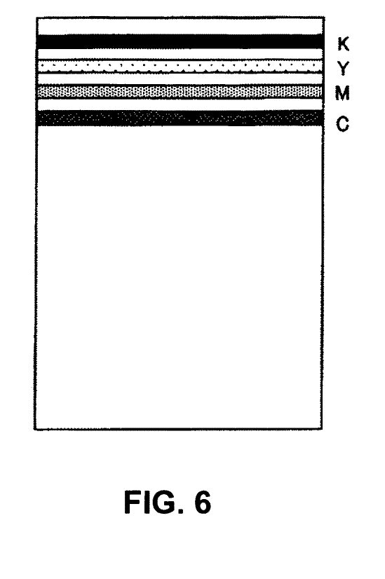

The evaluation was conducted in a continuous printing operation. FIG. 6 is a schematic view showing a print medium printed with the image forming apparatus in the continuous printing operation according to the first embodiment of the present invention. In the continuous printing operation, an image shown in FIG. 6 was printed on the print medium with the A4 size. As shown in FIG. 6, the image has lateral bar patterns printed in colors of black, yellow, magenta, and cyan at a print image density of 3%. In the continuous printing operation, 2,000 of the print media with the A4 size were printed alternately per one day for six days. At the print image density of 3%, each lateral bar pattern in colors of black, yellow, magenta, and cyan was printed in an area of 3% relative to an entire area of the print medium. Note that each lateral bar pattern with the print image density of 3% was formed of a solid image over a print area (no white dots).

The evaluation was conducted under an environmental condition of a temperature of 25 degrees and a humidity of 55% for two days; a temperature of 28 degrees and a humidity of 80% for two days; and a temperature of 10 degrees and a humidity of 20% for two days, i.e., a total of six days.

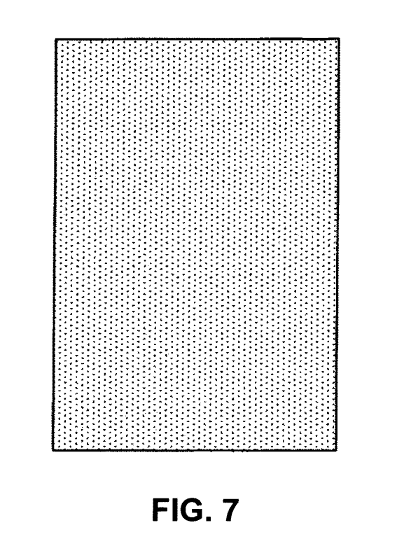

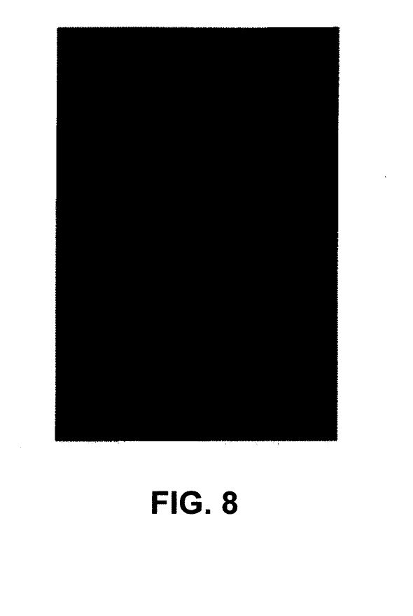

In the evaluation, evaluation samples were taken at the beginning of the continuous printing operation and every 2,000 sheets afterward. FIG. 7 is a schematic view showing a print medium with a half tone image printed with the image forming apparatus according to the first embodiment of the present invention. FIG. 8 is a schematic view showing a print medium with a solid image printed with the image forming apparatus according to the first embodiment of the present invention. The evaluation samples included the print media with the half tone image with the print image density of 25% formed thereon in each of colors of black, yellow, magenta, and cyan as shown in FIG. 7. Further, the evaluation samples included the print media with the solid image with the print image density of 100% formed thereon as shown in FIG. 8. Note that, in the print media with the half tone image with the print image density of 25%, dots were alternately formed in an area of 25% relative to an entire area of the print medium.

In the evaluation, the image forming apparatus C5900 (a product of OKI DATA Corporation) performed the continuous printing operation at a print speed of 26 ppm (in an A4 longitudinal direction), and the photosensitive drum 1 rotated a linear speed of 153 mm/sec. at an outer circumference thereof.

In the evaluation, the print media with the half tone image and the print media with the solid image printed in the continuous printing operation were visually examined to confirm a filming. When the filming occurred, a white streak or a white spot having a size of 0.5 mm was generated over a part or an entire area of the print medium. Through the visual examination, it was confirmed whether the print media had the filming.

FIG. 9 is a table showing evaluation results of the image forming apparatus according to the first embodiment of the present invention. As shown in FIG. 9, when the surface roughness of the photosensitive drum 1 increases, or the static frictional coefficient of the binder resin decreases, the filming decreases. When the surface roughness of the photosensitive drum 1 increases, the photosensitive drum 1 has a smaller contact area relative to toner, so that an outer additive of toner such as silica tends to stick to the photosensitive drum 1 less frequently. When the static frictional coefficient of the binder resin decreases, the outer additive of toner such as silica sticking to the photosensitive drum 1 does not come off and is not accumulated to a large extent. In summary, when the surface roughness of the photosensitive drum 1 increases, or the static frictional coefficient of the binder resin decreases, it is possible to reduce a printing problem due to the filming. In Table shown in FIG. 9, “X” represents the example having a poor filming level, “Δ” represents the example having a fair filming level, and “o” represents the example having a good filming level.

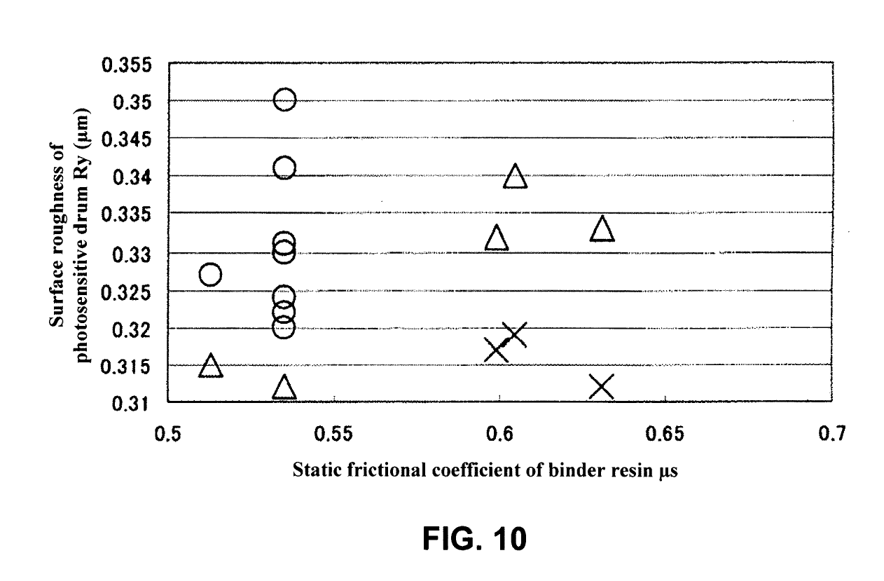

FIG. 10 is a graph showing the evaluation results of the image forming apparatus according to the first embodiment of the present invention. In FIG. 10, the vertical axis represents the static frictional coefficient μs of the binder resin, and the horizontal axis represents the maximum surface roughness Ry of the photosensitive drum 1.

AS shown in FIG. 10, when the static frictional coefficient μs of the binder resin contained in the electron charge transportation layer 27 of the photosensitive layer portion 23 is less than 0.535, and the maximum surface roughness Ry of the photosensitive drum 1 having the electron charge transportation layer 27 as the outer surface is greater than 0.32 μm, it is possible to prevent the a printing problem due to the filming.

As described above, in the image forming apparatus in the embodiment, the photosensitive drum 1 includes the surface layer formed of the binder resin having the static frictional coefficient less than 0.535, and having the maximum surface roughness greater than 0.32 μm. Accordingly, it is possible to stably form a good image without a printing problem due to the filming.

### Second Embodiment

A second embodiment of the present invention will be explained next. In the second embodiment, the image forming apparatus, the image forming unit 9, and the photosensitive drum 1 have configurations similar to those in the first embodiment, and explanations thereof are omitted.

In the second embodiment, the image forming unit or the image forming apparatus includes a cleaning blade 6 disposed to abut against the photosensitive drum 1 for cleaning the surface of the photosensitive drum 1. In addition to the photosensitive drum 1 in the first embodiment including the surface layer formed of the binder resin having the specific static frictional coefficient, and having the specific maximum surface roughness, in the second embodiment, it is configured that the cleaning blade 6 abuts against the photosensitive drum 1 with a specific pressing force. Note that the pressing force represents a force applied to the photosensitive drum 1 in a direction perpendicular to a tangential line at a contact point between a distal end portion of the cleaning blade 6 and the photosensitive drum 1.

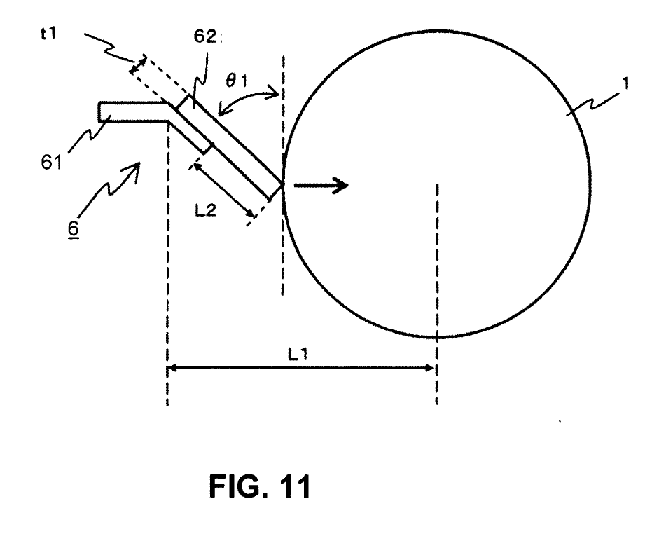

FIG. 11 is a schematic view showing the cleaning blade 6 of the image forming apparatus according to the second embodiment of the present invention. As shown in FIG. 11, the cleaning blade 6 includes a metal supporting plate 61 formed of SUS and a urethane rubber plate 62. The urethane rubber plate 62 is fixed to the metal supporting plate 61. The cleaning blade 6 is arranged such that a distance L1 between the cleaning blade 6 and a center of the photosensitive drum 1 becomes constant. A distal end portion of the urethane rubber plate 62 is arranged to abut against the photosensitive drum 1.

As described above, the cleaning blade 6 is arranged such that the distance L1 between the cleaning blade 6 and the center of the photosensitive drum 1 becomes constant. Accordingly, a contact angle θ1 relative to a tangential line at a contact point relative to the photosensitive drum 1 and a pressing force (gf·cm) at a contact point between the distal end portion of the urethane rubber plate 62 and the photosensitive drum 1 are determined by a rubber plate thickness t1 (mm) of the urethane rubber plate 62 and a free end length L2 (mm) of the urethane rubber plate 62 extending from the metal supporting plate 61.

In the embodiment, when the pressing force of the cleaning blade 6 exceeds 60 gf·cm, the photosensitive drum 1 tends to be deformed or damaged, thereby lowering print quality. Accordingly, the pressing force of the cleaning blade 6 is set to be less than 60 gf·cm.

In the embodiment, examples No. 1 to No. 6 of the cleaning blade 6 are prepared to have various rubber plate thicknesses t1 and free end lengths L2 as explained below. Note that the example No. 3 is used for the image forming unit 9 in the evaluation in the first embodiment.

The example No. 1 of the cleaning blade 6 have the rubber plate thickness t1 of 1.7 mm (t1=1.7 mm), and the free end lengths L2 of 7.5 mm (L2=7.5 mm). Accordingly, the pressing force becomes 15.6 gf·cm.

The example No. 2 of the cleaning blade 6 has the rubber plate thickness t1 of 1.8 mm (t1=1.8 mm), and the free end lengths L2 of 7.7 mm (L2=7.7 mm). Accordingly, the pressing force becomes 23.3 gf·cm.

The example No. 3 of the cleaning blade 6 has the rubber plate thickness t1 of 1.9 mm (t1=1.9 mm), and the free end lengths L2 of 7.5 mm (L2=7.5 mm). Accordingly, the pressing force becomes 30.6 gf·cm.

The example No. 4 of the cleaning blade 6 has the rubber plate thickness t1 of 2.0 mm (t1=2.0 mm), and the free end lengths L2 of 7.7 mm (L2=7.7 mm). Accordingly, the pressing force becomes 38.3 gf·cm.

The example No. 5 of the cleaning blade 6 has the rubber plate thickness t1 of 2.1 mm (t1=2.1 mm), and the free end lengths L2 of 7.7 mm (L2=7.7 mm). Accordingly, the pressing force becomes 47.8 gf·cm.

The example No. 6 of the cleaning blade 6 has the rubber plate thickness t1 of 2.1 mm (t1=2.1 mm), and the free end lengths L2 of 7.5 mm (L2=7.5 mm). Accordingly, the pressing force becomes 49.2 gf·cm.

The examples No. 1 to No. 6 of the cleaning blade 6 were evaluated with respect to the filming using the 16 examples of the photosensitive drum 1 explained in the first embodiment under conditions similar to those in the first embodiment. More specifically, the image forming apparatus performed the continuous printing operation under the environmental condition similar to the first embodiment. The evaluation samples were taken and evaluated according to the evaluation standard similar to the first embodiment.

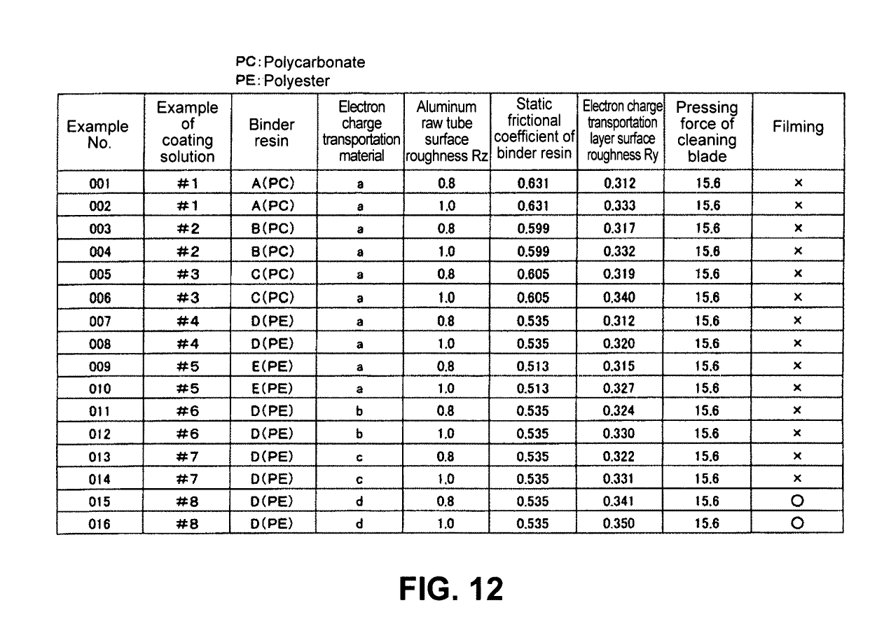

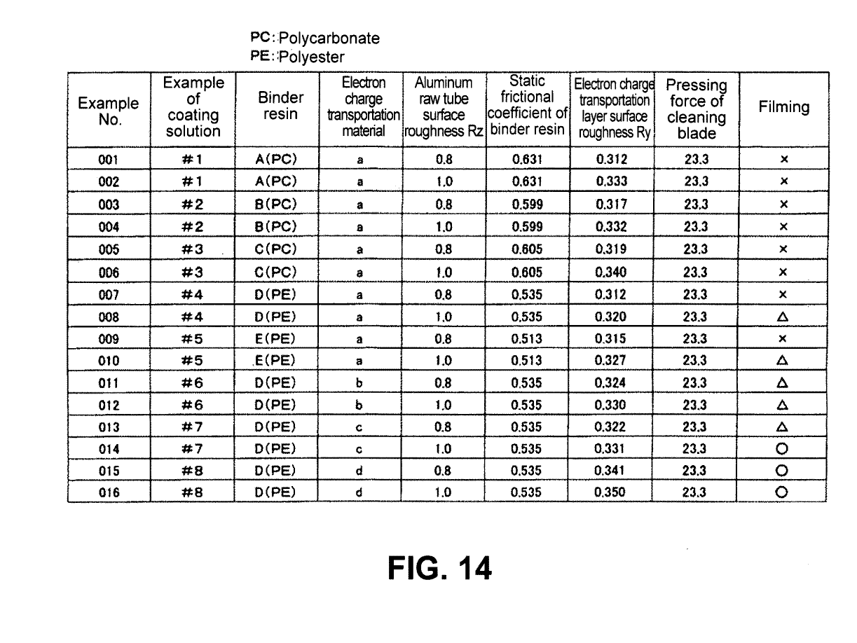

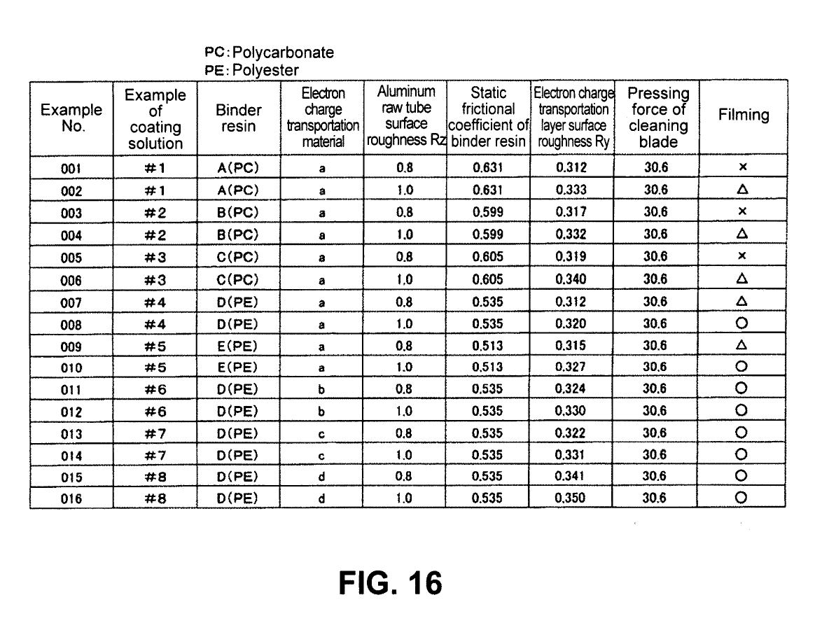

FIG. 12 is a table showing evaluation results of the example No. 1 of the cleaning blade 6 of the image forming apparatus according to the second embodiment of the present invention. FIG. 14 is a table showing evaluation results of an example No. 2 of the cleaning blade 6 of the image forming apparatus according to the second embodiment of the present invention. FIG. 16 is a table showing evaluation results of an example No. 3 of the cleaning blade 6 of the image forming apparatus according to the second embodiment of the present invention.

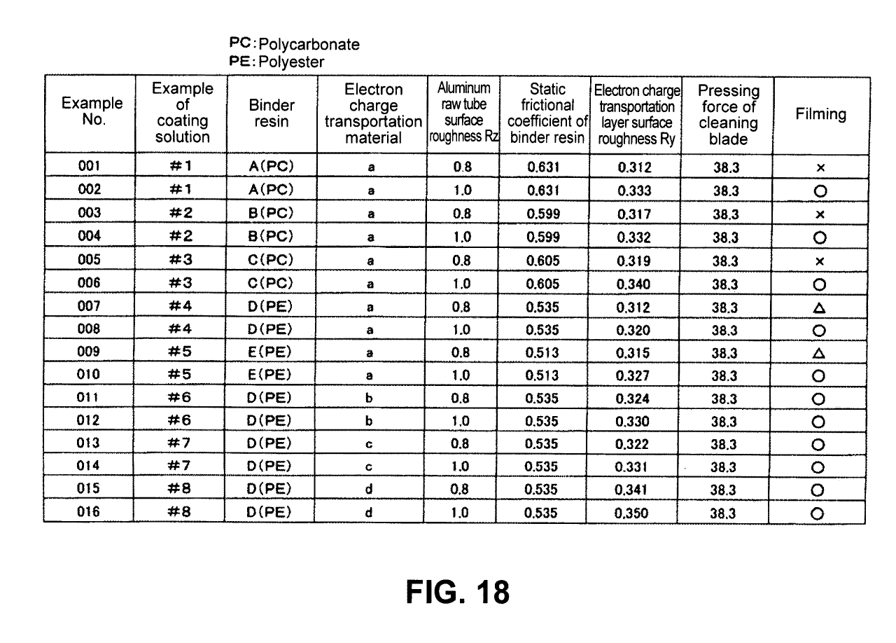

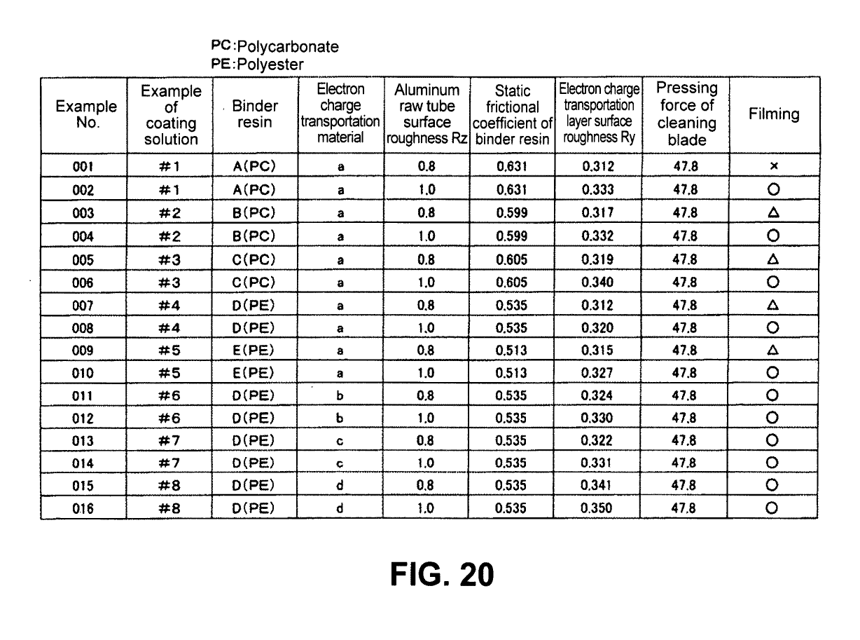

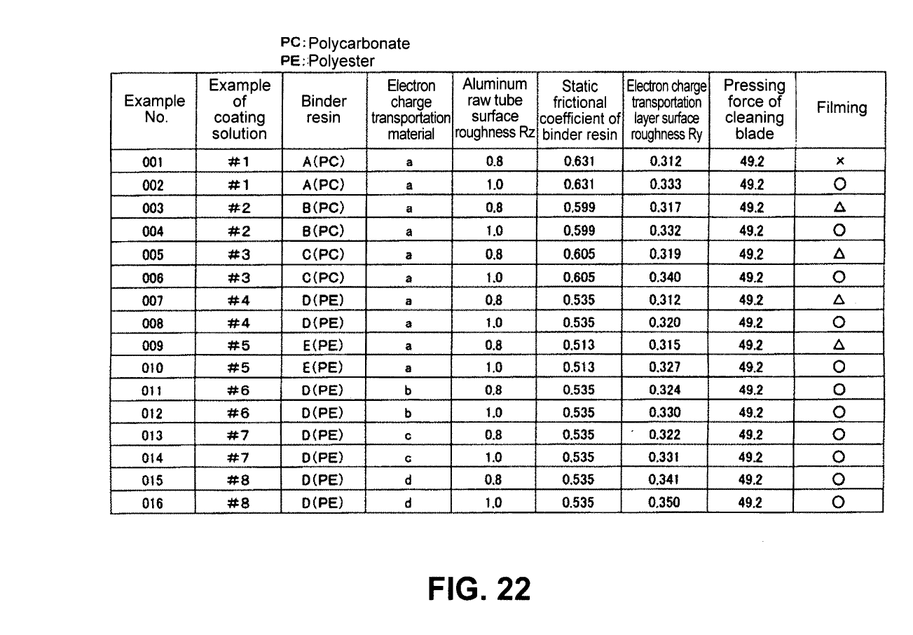

FIG. 18 is a table showing evaluation results of an example No. 4 of the cleaning blade 6 of the image forming apparatus according to the second embodiment of the present invention. FIG. 20 is a table showing evaluation results of an example No. 5 of the cleaning blade 6 of the image forming apparatus according to the second embodiment of the present invention. FIG. 22 is a table showing evaluation results of an example No. 6 of the cleaning blade 6 of the image forming apparatus according to the second embodiment of the present invention.

In Tables shown in FIGS. 12, 14, 16, 18, 20, and 22, “X” represents the example having a poor filming level, “Δ” represents the example having a fair filming level, and “o” represents the example having a good filming level.

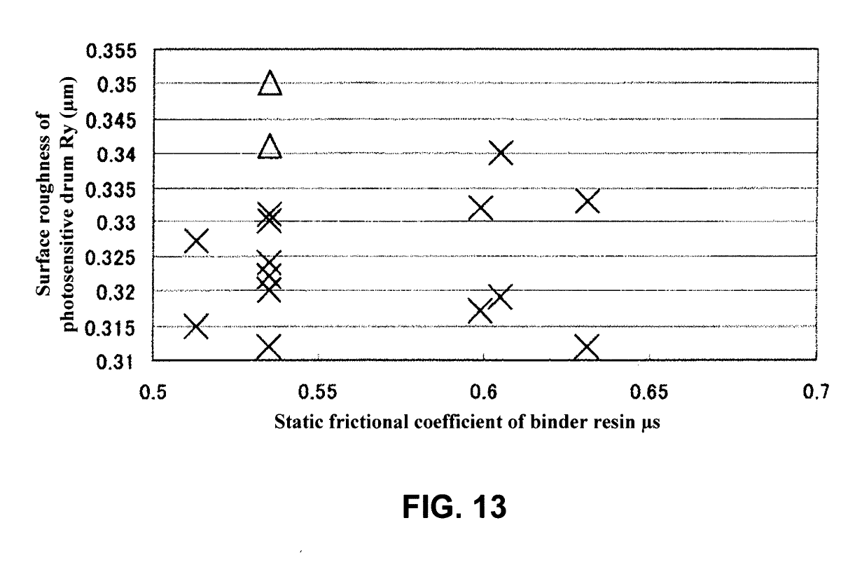

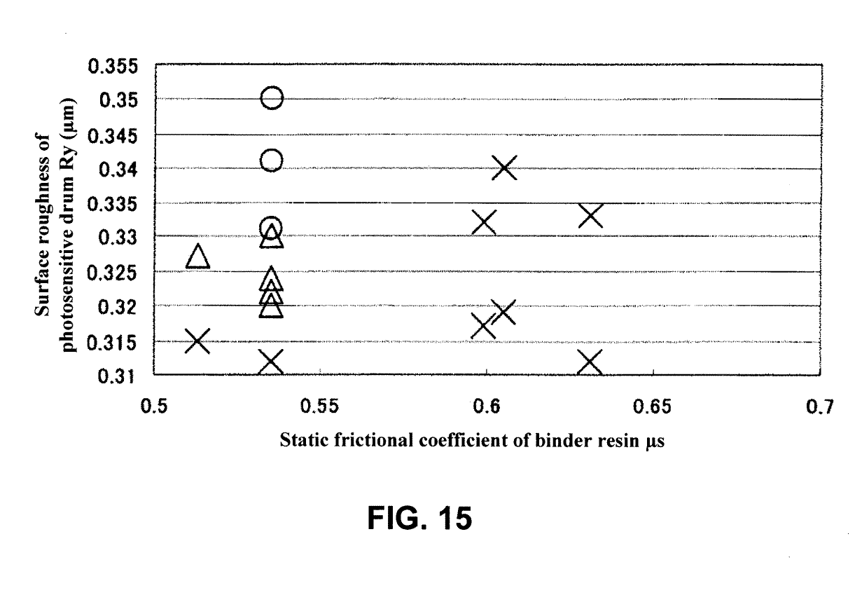

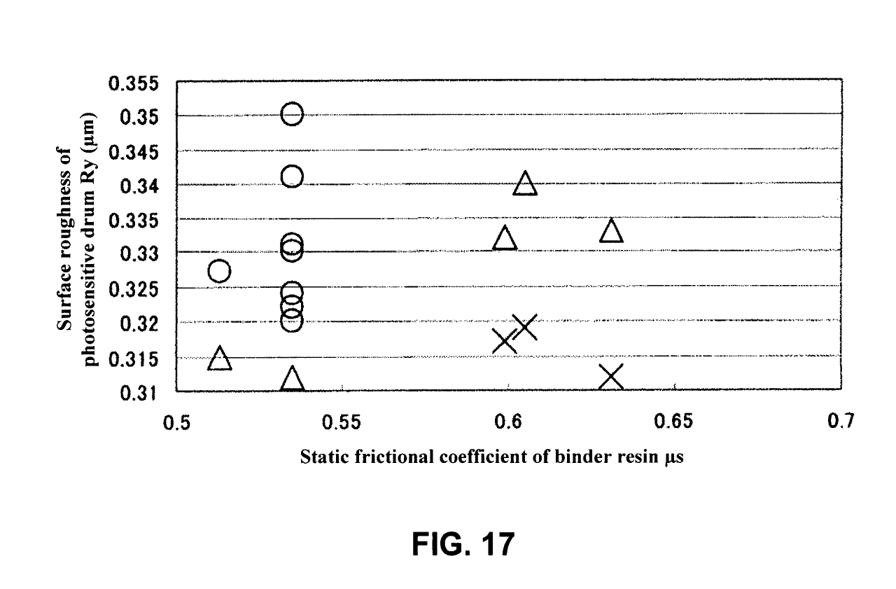

FIG. 13 is a graph showing the evaluation results of the example No. 1 of the cleaning blade 6 of the image forming apparatus according to the second embodiment of the present invention. FIG. 15 is a graph showing the evaluation results of the example No. 2 of the cleaning blade 6 of the image forming apparatus according to the second embodiment of the present invention. FIG. 17 is a graph showing the evaluation results of the example No. 3 of the cleaning blade 6 of the image forming apparatus according to the second embodiment of the present invention.

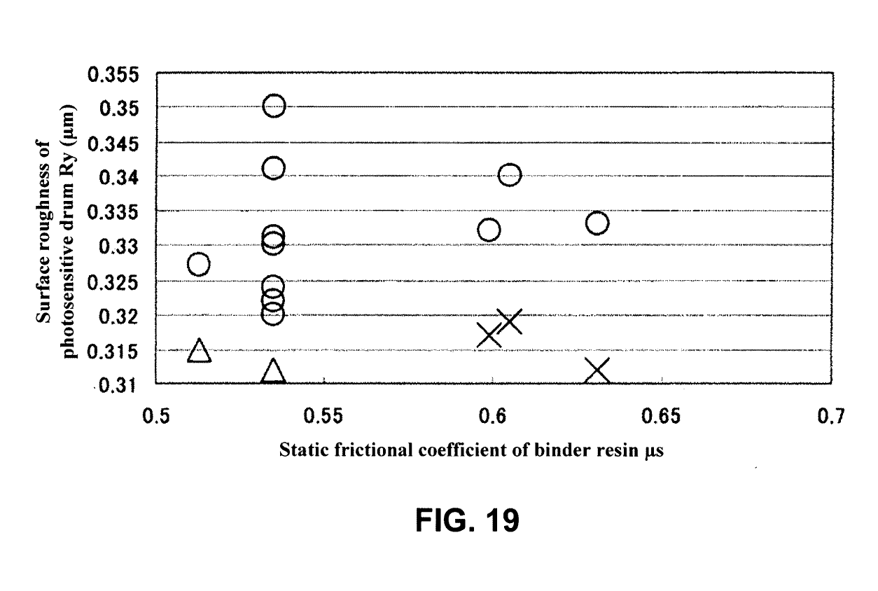

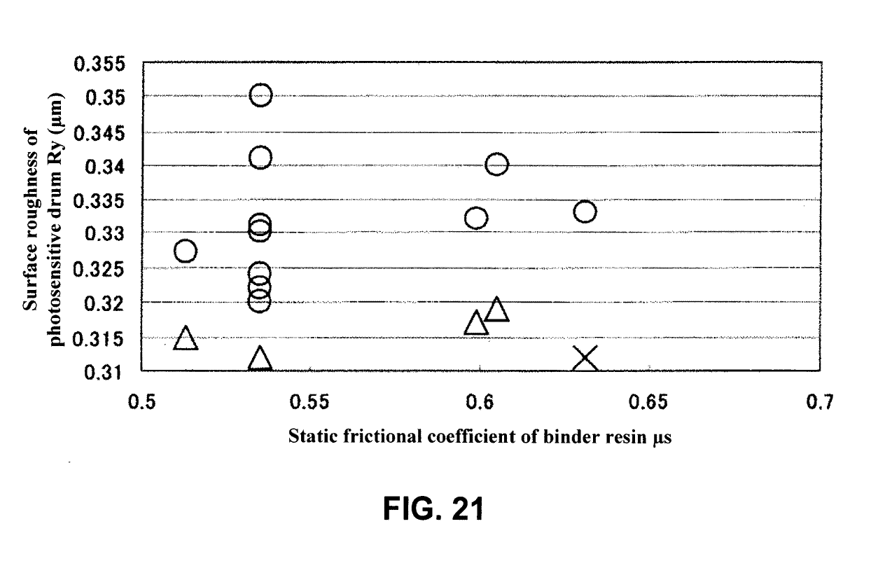

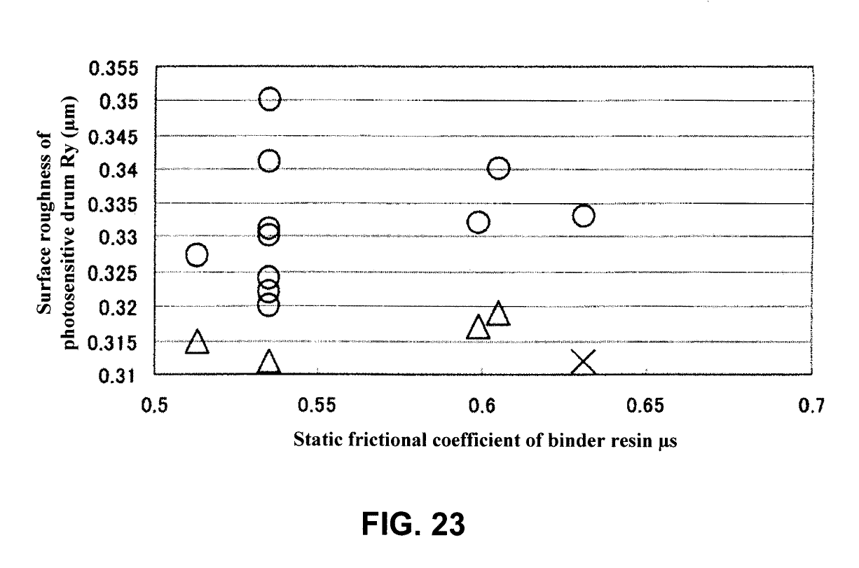

FIG. 19 is a graph showing the evaluation results of the example No. 4 of the cleaning blade 6 of the image forming apparatus according to the second embodiment of the present invention. FIG. 21 is a graph showing the evaluation results of the example No. 5 of the cleaning blade 6 of the image forming apparatus according to the second embodiment of the present invention. FIG. 23 is a graph showing the evaluation results of the example No. 6 of the cleaning blade 6 of the image forming apparatus according to the second embodiment of the present invention.

As shown in FIGS. 12 to 23, when the static frictional coefficient μs of the binder resin contained in the electron charge transportation layer 27 of the photosensitive layer portion 23 is less than 0.631, the pressing force of the cleaning blade 6 is greater than 38.3 gf·cm, and the maximum surface roughness Ry of the photosensitive drum 1 having the electron charge transportation layer 27 as the outer surface layer is greater than 0.32 μm, it is possible to prevent the a printing problem due to the filming.

As described above, in the image forming apparatus in the embodiment, the cleaning blade 6 or a cleaning member is arranged to abut against the photosensitive drum 1 with the pressing force greater than 38.3 gf·cm. Further, it is configured such that the photosensitive drum 1 includes the surface layer formed of the binder resin having the static frictional coefficient less than 0.631, and having the maximum surface roughness greater than 0.32 μm. Accordingly, it is possible to stably form a good image without a printing problem due to the filming.

In the first and second embodiments, in addition to the image forming apparatus and the image forming unit 9, the present invention is applicable to other image forming apparatus for forming an image or a text through an electro-photography process such as a copier, a scanner, a facsimile, an MFP (Multi-function Product), and the likes.

The disclosure of Japanese Patent Application No. 2008-143039, filed on May 30, 2008, is incorporated in the application by reference.

While the invention has been explained with reference to the specific embodiments of the invention, the explanation is illustrative and the invention is limited only by the appended claims.

What is claimed is:

1. An image forming unit, comprising:
a photosensitive member for forming a static latent image upon exposure and a developer image with developer, said photosensitive member including a surface layer formed of a binder resin having a static frictional coefficient equal to or less than 0.535, and having a maximum surface roughness equal to or greater than 0.32 μm.

2. An image forming unit, comprising:
a photosensitive member for forming a static latent image upon exposure and a developer image with developer, said photosensitive member including a surface layer formed of a binder resin having a static frictional coefficient equal to or less than 0.631, and having a maximum surface roughness equal to or greater than 0.32 μm; and
a cleaning member pressed against the photosensitive member with a pressing force equal to or greater than 38.3 gf·cm.

3. The image forming unit according to claim 1, wherein said surface layer includes an electron charge transportation layer formed of the binder resin.

4. The image forming unit according to claim 2, wherein said surface layer includes an electron charge transportation layer formed of the binder resin.

5. The image forming unit according to claim 1, wherein said electron charge transportation layer is situated at an outermost layer of the photosensitive member.

6. The image forming unit according to claim 2, wherein said electron charge transportation layer is situated at an outermost layer of the photosensitive member.

7. The image forming unit according to claim 1, wherein said photosensitive member includes a photosensitive drum formed in a cylindrical shape.

8. The image forming unit according to claim 7, wherein said photosensitive drum includes a conductive supporting member and a photosensitive layer.

9. The image forming unit according to claim 8, wherein said photosensitive layer is formed of a plurality of layers.

10. The image forming unit according to claim 8, wherein said photosensitive layer is formed of a blocking layer, an electron charge generation layer, and an electron charge transportation layer laminated on a surface of the conductive supporting member.

11. The image forming unit according to claim 1, wherein said surface layer has the maximum surface roughness less than 0.6 μm.

12. The image forming unit according to claim 1, wherein said photosensitive member is adopted to form the developer image with the developer having an average particle size of substantially 0.6 μm.

13. The image forming unit according to claim 1, wherein said photosensitive member is adopted to form the developer image with the developer formed of one non-magnetic component.

14. The image forming unit according to claim 1, wherein said photosensitive member is adopted to form the developer image with the developer formed of crashed toner.

15. The image forming unit according to claim 2, wherein said cleaning member includes a cleaning blade.

16. An image forming apparatus comprising the image forming unit according to claim 1.

17. An image forming apparatus comprising the image forming unit according to claim 2.
